(19) United States
(12) Patent Application Publication
(10) Pub. No.: US 2010/0085003 A1
(43) Pub. Date: Apr. 8, 2010

(54) APPARATUS AND METHOD FOR CONTROLLING AN ACTUATOR

(75) Inventor: Peter Spring, Montgomery, IL (US)

Correspondence Address: Caterpillar Inc.;Intellectual Property Dept., AH 9510, 100 N.E. Adams Street, PEORIA, IL, 61629-9510, US

(73) Assignee: CATERPILLAR INC., Peoria, IL (US)

(21) Appl. No.: 12/247,492

(22) Filed: Oct. 8, 2008

(51) Int. Cl. G05B 19/25; G05B 13/02

(52) U.S. Cl. 318/573; 318/561

(57) ABSTRACT

A controller for an actuator estimates the torque required to accelerate and decelerate an actuator and calculates a trajectory to a desired position based on the estimated torque requirements. The controller then determines an appropriate step size to move the actuator in the current time interval. Each time cycle the controller recalculates the trajectory to account for changes in conditions or operator inputs. The controller determines an appropriate step size to move the actuator in the next time interval based on the new trajectory.

### TECHNICAL FIELD

The present disclosure relates generally to a method for controlling an actuator, and more particularly to a method for adaptively controlling an actuator.

### BACKGROUND

Various machines utilize actuators such as step motors, solenoids, and so forth to control numerous functions on the machine. For example, such actuators may be used to control hydraulic valves. There is a continuing need to increase the accuracy and response time of such actuators.

One attempt to increase the response time of a step motor is described in U.S. Pat. No. 6,984,956 (the '956 patent). The method disclosed in the '956 patent switches between micro-stepping and full-stepping configurations at certain stages along a predetermined path of the step motor. However, the method disclosed in the '956 patent assumes a constant trajectory and is not adaptable to trajectory changes made in the middle of the predetermined path.

### SUMMARY OF THE DISCLOSURE

In one aspect of the disclosure a method of controlling an actuator is disclosed. According to this method a controller calculates a first trajectory from a first position to a second position based on a first set of boundary conditions, and commands movement of the actuator based on the first trajectory. The controller then calculates a second trajectory from a third position to a fourth position based on a second set of boundary conditions, wherein the third position is between the first position and the second position. Before the actuator reaches the second position, the controller commands movement of the actuator based on the second trajectory.

### BRIEF DESCRIPTION OF THE DRAWINGS

FIG. 1 is a side diagrammatic view of a machine, according to the present disclosure;

FIG. 2 is a schematic view of an exemplary embodiment of a hydraulic control system, according to the present disclosure;

FIG. 3 is a diagram illustrating current configurations in a full-stepping sequence;

FIG. 4 is a diagram illustrating current configurations in a half-stepping sequence;

FIG. 5 is a flow chart illustrating an exemplary method of controlling an actuator; and

FIG. 6 is a chart illustrating first and second trajectories and actual actuator positions according to an exemplary embodiment of the present disclosure.

### DETAILED DESCRIPTION

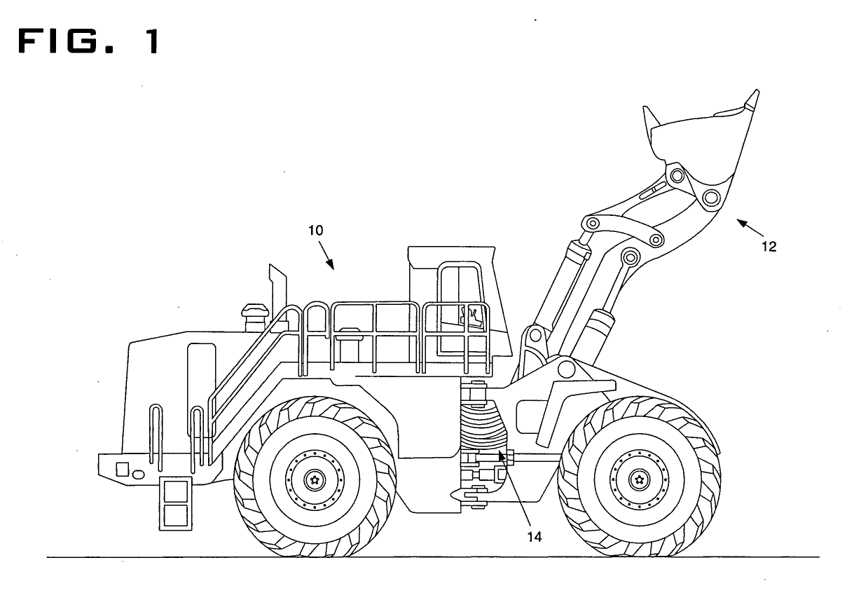

An exemplary embodiment of a machine 10 is shown generally in FIG. 1. The machine 10 may be a wheel loader, as shown, or any other off-highway or on-highway machine. The machine 10 may have one or more implements 12; in the exemplary embodiment the implement 12 is a bucket. The implement 12 may be controlled by a hydraulic system 14, which may include a pump, hydraulic lines, hydraulic valves and other hydraulic components that are known in the art.

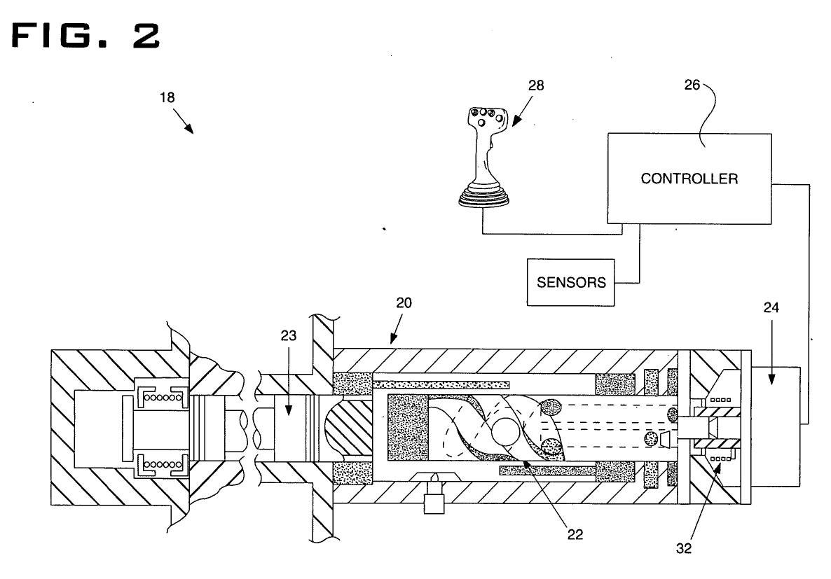

Referring to FIG. 2, a hydraulic control system 18 is illustrated. The hydraulic control system 18 may contain a valve 20 that controls the direction and/or amount of flow of hydraulic fluid through the valve 20 based on the position of a movable member. In the depicted embodiment the movable member is a rotary spool 22, but the movable member may be a poppet or any other such member known in the art. Reference to the spool 22 as a movable member is for exemplary purposes only; the movable member may refer to a device that is not a hydraulic device. The position of the movable member may be adjusted by a valve actuator. In the present embodiment, the valve actuator is a bipolar step motor 24 as is known in the art; however, the actuator may be another type of step motor, a solenoid or any other actuator known in the art. Furthermore, the step motor 24 may be controlled by a controller 26.

In the depicted embodiment the valve 20 is a rotary servo spool valve, such as the device disclosed in U.S. patent application having Ser. No. 11/643,818 (the '818 application) filed by Kerckhove et al. on Dec. 22, 2006, which is incorporated herein by reference. In addition to the rotary spool 22, the depicted valve 20 includes a translatory spool 23. In practice the rotary spool 22 opens and closes ports that cause the translatory spool 23 to change position; the translatory spool 23, in turn, controls hydraulic flow to the implement 12. The interaction between the rotary spool 22 and the translatory spool 23 is discussed in greater detail in the '818 application.

The direction and rate of flow of hydraulic fluid through the valve 20 is affected by the angular position of the rotary spool 22, which is controlled by the step motor 24. The desired rate and direction of flow of hydraulic fluid through the valve 20 may be a function of a signal generated by an operator input device 28, which may be connected to the controller 26, or various other inputs.

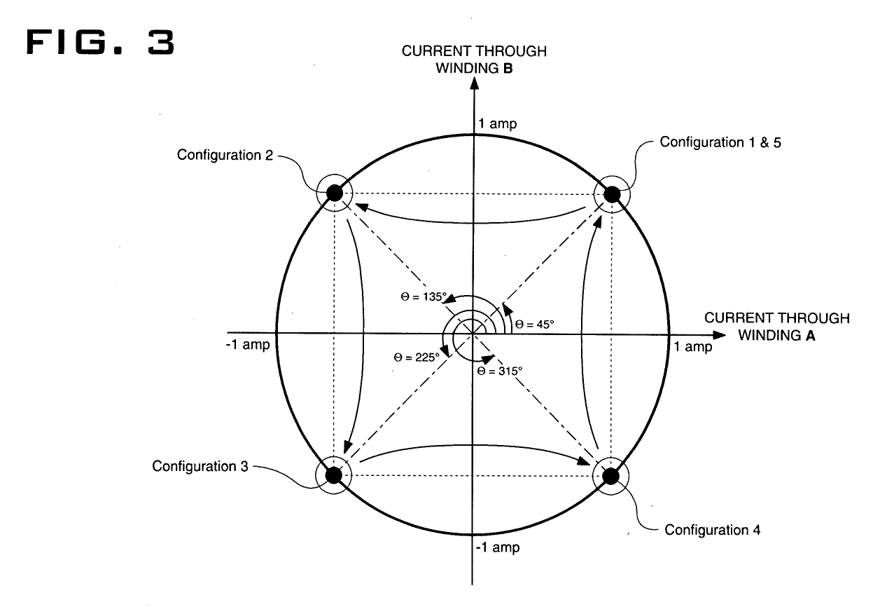

According to an embodiment of the disclosure, the step motor 24 has two sets of windings, Winding A and Winding B, each of which may selectively generate magnetic fields in one of two opposite directions. Generally, a step motor 24 may be operated in either a full-stepping mode or a micro-stepping mode. In full-stepping mode the electrical currents through Winding A and Winding B repeat a sequence of four configurations. An example of such a full-stepping series of electrical current configurations is illustrated in Table 1 below. As used herein, the angle θ represents the polar angle in a plane IA over IB, where the possible electrical current configurations define a circle, as illustrated in FIG. 3. The angle φ represents the angular position of the step motor 24.

TABLE 1
Illustrative table of current configurations in full-stepping mode.

| Configuration | Winding A (I_{A}) | | Winding B (I_{B}) | | θ | φ |
|---|---|---|---|---|---|---|
| Configuration 1 | 0.71 | Amps | 0.71 | Amps | 45° | 0.0° |
| Configuration 2 | −0.71 | Amps | 0.71 | Amps | 135° | 1.8° |
| Configuration 3 | −0.71 | Amps | −0.71 | Amps | 225° | 3.6° |
| Configuration 4 | 0.71 | Amps | −0.71 | Amps | 315° | 5.4° |
| Configuration 5 | 0.71 | Amps | 0.71 | Amps | 45° | 7.2° |

In full stepping mode a step motor 24 rotates by a predetermined angle for each step. Each step may be, for example, 1.8°, 0.9°, or numerous other step sizes. In the depicted embodiment, the step size is 1.8 degrees. Thus, when the bipolar step motor 24 is operated in a full-stepping mode, the rotor moves 1.8 degrees for each full step.

The bipolar step motor 24 may also be operated in a micro-stepping mode to increase resolution and to obtain smoother motion. In micro-stepping mode the four current configurations of the full-stepping mode are replaced by a sequence of, for example, eight, sixteen, thirty-two, sixty-four, or more current configuration. In an optimized micro-stepping mode the current in Winding A can be expressed as a sine curve, while the current in Winding B can be expressed as a cosine curve. Thus, for a maximum current of Iₘₐₓ, the current passing through Windings A and B, can be expressed as:

I_{A}=Iₘₐₓ sin(θ)

I_{B}=Iₘₐₓ cos(θ)

Applying the above equations, each step for θ will be (90/n) degrees, and each step for φ will be (1.8/n) degrees, where “n” is the number of micro-steps.

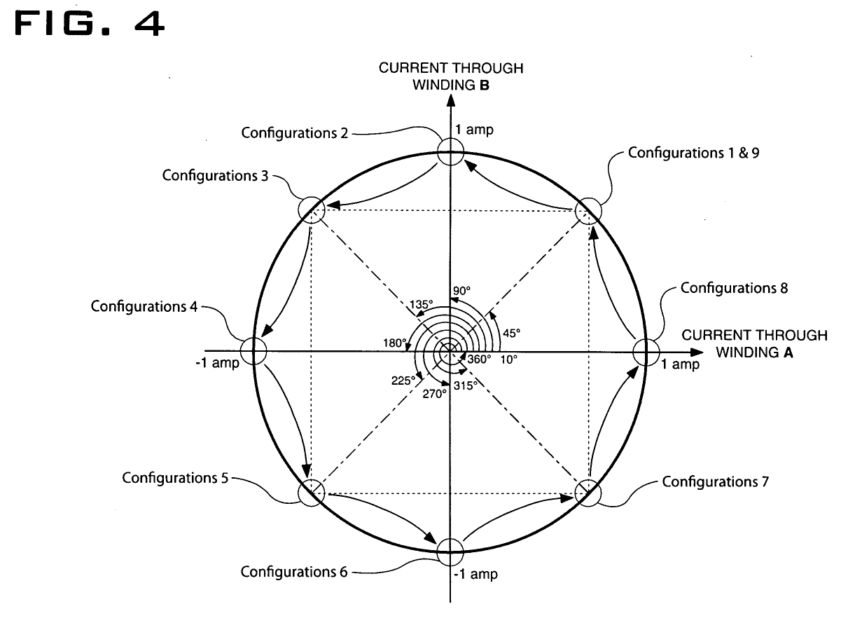

An example of a micro-stepping sequence, more specifically a so-called “half-stepping” sequence, having Iₘₐₓ=1 Amp, and eight electrical current configurations is illustrated in FIG. 4 and Table 2 below.

TABLE 2
Illustrative table of current configurations in micro-stepping mode.

| Configuration | Winding A | | Winding B | | θ | φ |
|---|---|---|---|---|---|---|
| Configuration 1 | 0.71 | Amps | 0.71 | Amps | 45° | 0.0° |
| Configuration 2 | 0.0 | Amp | 1.0 | Amp | 90° | 0.9° |
| Configuration 3 | −0.71 | Amp | 0.71 | Amp | 135° | 1.8° |
| Configuration 4 | −1.0 | Amp | 0.0 | Amp | 180° | 2.7° |
| Configuration 5 | −0.71 | Amp | −0.71 | Amp | 225° | 3.6° |
| Configuration 6 | 0.0 | Amp | −1.0 | Amp | 270° | 4.5° |
| Configuration 7 | 0.71 | Amp | −0.71 | Amp | 315° | 5.4° |
| Configuration 8 | 1.0 | Amp | 0.0 | Amp | 360°/0° | 6.3° |
| Configuration 9 | 0.71 | Amp | 0.71 | Amp | 45° | 7.2° |

Thus, according to the present embodiment having 1.8 degree full-steps, it will be understood that if a micro-stepping sequence having eight electrical current configurations is utilized, each micro-step will be ½ of 1.8 degrees, or 0.90 degrees. Similarly, if a micro-stepping sequence having sixteen electrical current configurations is utilized, each micro-step will be ¼ of 1.8 degrees, or 0.45 degrees.

With regard to the physical structure of the valve 20, the step motor 24 requires a certain amount of torque to rotate the spool 22 in order to overcome friction, inertia, a return spring 32, and/or various other forces acting on the step motor 24 and/or spool 22. The step motor 24 may lose its phase if the torque necessary to drive the spool 22 over the next step angle is higher than the torque that can be produced by the step motor 24. In such a situation, the step motor 24 may miss a step. If this occurs more than twice, the step motor 24 will become out of phase, i.e. the step motor 24 position will jump to the nearest position that matches the actual current configuration. In such a case the motor position will be four steps, or 7.2° off the commanded position. If this occurs in an open loop control system, the controller 26 will have an inaccurate perception of the step motor's 24 position. According to the present disclosure, this could result in improper positioning of the spool 22.

To avoid missing steps, the controller 26 according to the present disclosure may continuously estimate the torque required for the step motor 24 to turn the spool 22. The controller 26 may operate at a given frequency, such as 50 Hz, 100 Hz, 200 Hz, or numerous other frequencies. Thus, by “continuously estimate” it is meant that the controller 26 may estimate the torque required by the step motor 24 each cycle (e.g. 50 times per second for 50 Hz system, and so forth). Alternately, the controller 26 may estimate the torque required by the system regularly, but less than each cycle (e.g. 5 times per second regardless of the controller clock speed). Based at least in part on the estimated torque requirements, the controller 26 may limit the maximum step angle per time increment. In an application such as the hydraulic valve 20 depicted in FIG. 2, the torque may be modeled considering such factors as inertia, viscous and non-viscous friction, and the torque caused by a return spring 32.

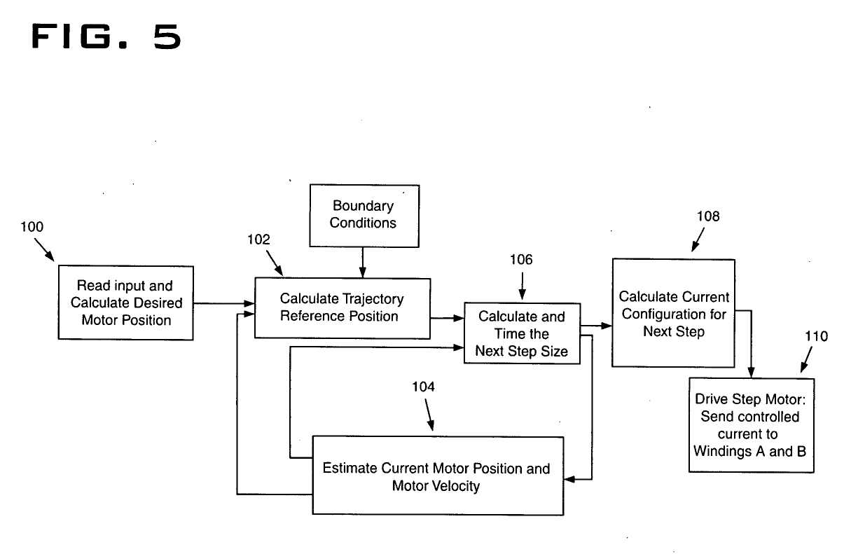

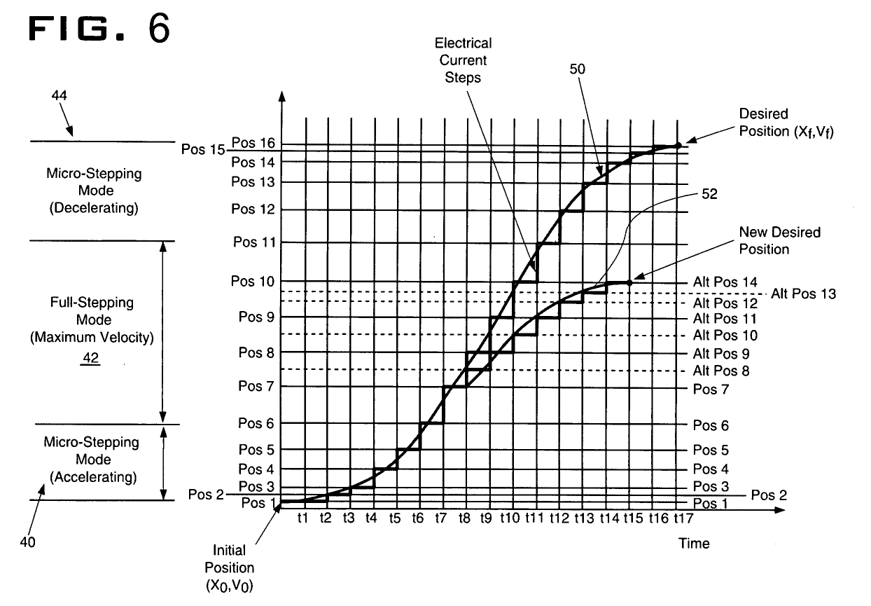

FIG. 5 illustrates an exemplary algorithm that may be followed by the controller 26 each time increment, whether it be each cycle of the controller 26 or another predetermined time increment. As illustrated in FIGS. 2 and 5, controller 26 references an input to determine a desired step motor 24 position (100). The controller 26 then calculates a reference trajectory 50 (see FIG. 6) to achieve the desired step motor 24 position (102). The calculation of this reference trajectory 50 is discussed in greater detail below.

The controller 26 also estimates a current step motor 24 position and velocity (104). The step motor 24 velocity is estimated by dividing the last step angle by the time since the last step. If no step has been commanded for a certain amount of time, which may be a fraction of a second, the step motor 24 velocity may be determined to be zero. The step motor 24 position is estimated by summing all of the past commanded step angles since the last initialization of the algorithm.

As a function of the calculated reference trajectory 50 and the estimated motor position and motor velocity and given the controller clock time, the controller 26 determines the appropriate size of the next step (106). The size of the next step generally follows the reference trajectory 50, as illustrated in FIG. 6. Based upon the next angular step size calculated in procedure 106, as well as the estimated actual step motor 24 position, the appropriate electrical current configuration through Windings A and B is determined (108), and such current configuration is passed through the windings (110).

The reference trajectory 50 calculated in procedure (102) is constrained by the maximum acceleration and deceleration of the stepper motor 24. The maximum acceleration and deceleration of the stepper motor 24 depend, at least in part, on the torque required to change the angular velocity of the stepper motor 24 with the load attached at its output shaft at a given position. The torque required to change the angular velocity of the stepper motor 24 and its load may depend, among other things, on the stepper motor 24 position due to such factors as the return spring 32 and friction.

The maximum acceleration and deceleration of the stepper motor 24 in a given position may vary based on the various characteristics of the hydraulic control system 18. As such it may be necessary to empirically determine the maximum acceleration and deceleration for a given hydraulic control system 18 at various positions along the path of the actuator.

Thus, if the maximum acceleration, maximum deceleration, and a sufficient set of boundary condition, which may include, for example, initial position (xₒ), initial velocity (vₒ), desired position (x_{f}), and final velocity (v_{f}), are known, a reference trajectory 50 (see FIG. 6) that allows the step motor 24 to travel from the initial position (xₒ) to the desired position (x_{f}) without exceeding the torque generated by the step motor can be calculated based on fundamental, known equations of motion. The final velocity is essentially the maximum velocity at which the holding torque of the stepper motor will stop the rotor with attached load from passing on to the next angular position that matches the electrical current configuration of the desired position. The maximum final velocity may need to be determined empirically.

As illustrated in FIG. 6, micro-stepping is utilized when the reference trajectory 50 dictates low velocity, such as when accelerating or decelerating. Lower velocities may require smaller micro-steps, and higher velocities may require full-stepping. For example, with regard to the present disclosure having a 1.8 degree full step, for a given reference trajectory in the acceleration phase 40 the controller 26 may initially command a number of fourth steps (0.45°), then half steps (0.9°); the controller may then enter a full-stepping (1.8°) phase 42 and command full-steps for as long as possible to maintain maximum velocity, and, thus, responsiveness. According to this example, when necessary to decelerate, the controller 26 may enter a deceleration phase 44 and command 8 step (0.45 degree) micro-steps, then 16 step (0.225) micro-steps. The use of sufficiently smaller steps while accelerating and decelerating ensures accuracy, as the step motor 24 will be unlikely to miss a step. Alternatively, the controller 26 may not use conventional fractional micro-steps, rather the controller 26 may calculate and command the electrical current configuration appropriate for the next step along the reference trajectory 50, as may be calculated based on the trigonometric equations for I_{A} and I_{B} provided above.

Continuing the example discussed above and illustrated in FIG. 6, if the boundary conditions change before the step motor 24 reaches the desired position (x_{f}) an alternate reference trajectory 52 may be determined. For example, in the embodiment shown in FIG. 6, if between “t7” and “t8” the desired position changes, which may be caused by a change in an operator input or other change in the machine, the reference trajectory 50 would change, as illustrated by the alternate reference trajectory 52. As the reference trajectory 50 changes, so would the step sizes, as illustrated by “Alt Pos 8” through “Alt Pos 14”, which would represent the steps after the change in desired position. While FIG. 6 illustrates one change in trajectory resulting two different trajectories, in practice the trajectory could change every time cycle, which could result in hundreds of different trajectories every second.

### INDUSTRIAL APPLICABILITY

In operation, an operator of the machine 10 may command a desired function of the implement 12. This desired function may be achieved, at least in part, by moving a spool 22 within a valve 20 to a certain desired position. To move the spool 22 from its current position to the desired position as quickly and accurately as possible, the controller 26 will calculate a reference trajectory 50, as described above. The controller 26 will then calculate and command the next step, which will generally follow the reference trajectory 50, which may be a micro-step for relatively low velocities, or a full-step if the velocity is high.

However, before the spool 22 reaches the initial desired position, the operator may alter the command, and a new desired position may be requested. If this happens, at the controller's 26 next cycle, which will generally be a fraction of a second, the controller 26 will calculate an alternative reference trajectory 52 based on the current state of the hydraulic control system 18 and the new desired position. The controller 26 will then calculate and command the next step based on the alternate reference trajectory 52. According to an embodiment of the disclosure, the controller 26 may calculate a reference trajectory 50 and corresponding next step size each time cycle, regardless of any change in the boundary conditions. In this manner, the hydraulic control system 18 can adapt to changes in operator and/or other inputs, and can provide improved response time and accuracy. Furthermore, the system 18 can minimize the risk that the step motor 24 will miss steps.

It will be apparent to those skilled in the art that various modifications and variations can be made to the disclosed hydraulic control system 18 without departing from the scope or spirit of the disclosure. In particular, all the considerations regarding the optimized trajectory may be applied to linear motion, so torque would be replaced by force, angle would be replaced by distance, and so forth. Additionally, other embodiments of the disclosed hydraulic control system 18 will be apparent to those skilled in the art from consideration of the specification and practice of the apparatus and method disclosed herein. It is intended that the specification and examples be considered as exemplary only.

What is claimed is:

1. A method of controlling an actuator comprising the steps:
calculating a first trajectory from a first position to a second position based on a first set of boundary conditions,
commanding movement of the actuator based on the first trajectory,
calculating a second trajectory from a third position to a fourth position based on a second set of boundary conditions, wherein the third position is between the first position and the second position, and
commanding movement of the actuator based on the second trajectory before the actuator reaches the second position.

2. The method of claim 1, further comprising the step of determining a first maximum acceleration, wherein the calculation of the first trajectory is based on the first maximum acceleration.

3. The method of claim 2, wherein the first maximum acceleration is a function of the position of the actuator.

4. The method of claim 3, wherein the first maximum acceleration is empirically determined.

5. The method of claim 2, further comprising the step of determining a first maximum deceleration, wherein the calculation of the first trajectory is based on the first maximum deceleration.

6. The method of claim 2, further comprising the step of determining a second maximum acceleration, wherein the calculation of the second trajectory is based on the second maximum acceleration.

7. The method of claim 6, wherein the first maximum acceleration is greater than or less than the second maximum acceleration.

8. The method of claim 1, where the second set of boundary conditions includes an initial velocity.

9. The method of claim 8, wherein the initial velocity is greater than zero.

10. The method of claim 1, wherein the actuator is a step motor.

11. A machine comprising:
an operator input device configured to generate a first signal and a second signal, an actuator; and
a controller configured to:
receive the first signal and the second signal,
calculate a first trajectory from a first position to a second position based on the first signal,
cause the actuator to move based on the first trajectory,
calculate a second trajectory from a third position to a fourth position based on the second signal, the third position being between the first position and the second position,
cause the actuator to move based on the second trajectory before the actuator reaches the second position.

12. A method of controlling a step motor comprising the steps:
(i) calculating a first trajectory from a first angular position to a second angular position,
(ii) determining a first step size based on the first trajectory,
(iii) moving the step motor by the first step size,
(iv) calculating a second trajectory from a third angular position to a fourth angular position, wherein the third angular position is between the first angular position and the second angular position, and wherein this step is performed before the step motor reaches the second angular position,
(v) determining a second step size based on the second trajectory, and
(vi) moving the step motor by the second step size.

13. The method of claim 12, wherein the steps are performed in the following order: (i), (ii), (iii), (iv), (v), then (vi).

14. The method of claim 12, further comprising the steps:
(vii) determining a third step size based on the second trajectory, wherein the third step size is larger than then second step size, and
(viii) moving the step motor by the third step size.

15. The method of claim 14, wherein steps (vii) and (viii) are performed after step (vi).

16. The method of claim 15, further comprising the steps:
(ix) determining a fourth step size based on the second trajectory, wherein the fourth step size is smaller than the third step size, and
(x) moving the step motor by the fourth step size.

17. The method of claim 16, wherein steps (ix) and (x) are performed after step (viii).

18. The method of claim 12, further comprising the step of determining a first maximum acceleration, wherein the calculation of the first trajectory is based on the first maximum acceleration.

19. The method of claim 18, further comprising the step of determining a second maximum acceleration, wherein the calculation of the second trajectory is based on the second maximum acceleration.

20. The method of claim 19, wherein the first maximum acceleration is greater than or less than the second maximum acceleration.
